(19) United States
(12) Patent Application Publication
(10) Pub. No.: US 2016/0129694 A1
(43) Pub. Date: May 12, 2016

(54) LIQUID EJECTING APPARATUS AND WIPING METHOD THEREOF

(71) Applicant: SEIKO EPSON CORPORATION, Tokyo (JP)

(72) Inventor: Masahisa NAWANO, Suwa-shi (JP)

(21) Appl. No.: 14/932,087

(22) Filed: Nov. 4, 2015

(30) Foreign Application Priority Data
Nov. 12, 2014 (JP) 2014-229822

(51) Int. Cl. B41J 2/165

(52) U.S. Cl. CPC B41J 2/16535

(57) ABSTRACT

There is provided a liquid ejecting apparatus including a liquid ejecting unit that has a nozzle row configured to have a plurality of nozzles lined up along a first direction, and a wiping portion that moves in a second direction intersecting the first direction such that the liquid ejecting unit is wiped, in which the liquid ejecting unit includes a plurality of nozzle rows configured to have space therebetween in the second direction, a convex portion placed between the nozzle rows in the second direction, and flat portions placed at both sides of the convex portion in the first direction, and the wiping portion wipes at a first relative travel speed to collect liquid attached to the liquid ejecting unit to the flat portion, and then wipes at a second relative travel speed faster than the first relative travel speed to move liquid attached to the flat portion.

### BACKGROUND

1. Technical Field

The present invention relates to a liquid ejecting apparatus, such as an ink jet printer, and a method of wiping the liquid ejecting apparatus.

2. Related Art

As an example of the liquid ejecting apparatus, ink jet printers has been known which eject ink (liquid) onto a sheet (a target) through nozzles of a liquid ejecting head (a liquid ejecting unit) so that an image or the like is printed. To maintain good liquid ejecting performance of the nozzles, such printers may have a wiper unit to remove ink mist and the like attached to a nozzle surface on which the nozzles of the liquid ejecting head are formed (for example, see JP-A-2013-216011).

Moreover, the printer may have a convex portion provided on the nozzle surface to suppress contact between a sheet deformed due to liquid attached thereto and the nozzles. In this case, the nozzle surface having the convex portion is subject to a wiping operation with a liquid absorbing body made of a fiber based material.

In the case of performing a wiping operation with the liquid absorbing body, the nozzles may absorb liquid so that air bubbles enter the nozzles; and a raveling from the liquid absorbing body may enter the nozzles. In this case, the nozzle cannot eject liquid appropriately.

Furthermore, such a problem does not occur only in the case of wiping the liquid ejecting head of a printer that prints an image by ejecting ink. Such a problem may occur in any case where a liquid ejecting unit of a liquid ejecting apparatus is wiped.

### SUMMARY

An advantage of some aspects of the invention is to provide a liquid ejecting apparatus and a wiping method thereof in which liquid ejecting unit having a convex portion can be wiped efficiently.

Hereinafter, means of the invention and operation effects thereof will be described.

According to an aspect of the invention, there is provided a liquid ejecting apparatus including a liquid ejecting unit that has a nozzle row configured to have a plurality of nozzles lined up along a first direction, and ejects liquid through the nozzles configuring the nozzle row, and a wiping portion that moves relative to the liquid ejecting unit in a second direction intersecting the first direction such that the liquid ejecting unit is wiped, in which the liquid ejecting unit includes a plurality of nozzle rows configured to have space therebetween in the second direction, a convex portion placed between the nozzle rows in the second direction, and flat portions placed at both sides of the convex portion in the first direction, and the wiping portion wipes the liquid ejecting unit at a first relative travel speed to collect liquid attached to the liquid ejecting unit to the flat portion, and then wipes the liquid ejecting unit at a second relative travel speed faster than the first relative travel speed to move liquid attached to the flat portion.

In the case of wiping the liquid ejecting unit with the wiping portion traveling relative to the liquid ejecting unit, when a relative travel speed of the wiping portion relative to the liquid ejecting unit is low, a space between the nozzle row and the convex portion can be wiped efficiently by the wiping portion, but liquid is likely to remain in the flat portion. On the other hand, when the relative travel speed of the wiping portion relative to the liquid ejecting unit is high, liquid is likely to remain between the nozzle row and the convex portion, but the flat portion can be wiped efficiently by the wiping portion. It is considered that there is enough time for liquid to be moved to the flat portion when the relative travel speed of the wiping portion relative to the liquid ejecting unit is low, the liquid being sandwiched between the wiping portion and the convex portion at the time when the wiping portion is in contact with the convex portion; and on the other hand, the wiping portion passes through the convex portion before the liquid is moved to the flat portion when relative travel speed of the wiping portion relative to the liquid ejecting unit is high. Moreover, the amount of liquid able to be moved by the wiping portion is changed depending on the relative travel speed of the wiping portion relative to the liquid ejecting unit; the amount of liquid that can be moved in the case of a high relative travel speed is greater than that in the case of a low relative travel speed. Therefore, it is considered that liquid can be moved from a space between the nozzle row and the convex portion to the flat portion in the case of a low relative travel speed; liquid, however, is likely to remain because only small amount of liquid is moved from the flat portion. In this configuration, the wiping of the liquid ejecting unit at the first relative travel speed, which is relatively low speed, is performed first to move the liquid attached in the space between the nozzle row and the convex portion of the liquid ejecting unit to the flat portion, and then the wiping of the liquid ejecting unit at the second relative travel speed, which is relatively high speed, is performed to wipe the liquid remaining in the flat portion, whereby both the convex portion and the flat portion can be wiped efficiently. Therefore, it is not necessary to absorb liquid by the wiping portion, the wiping portion can be made of an elastic body such as an elastomer and a wiping of the liquid ejecting unit which has the convex portion can be performed efficiently.

In the liquid ejecting apparatus, the convex portion is preferably provided along a third direction intersecting a protrusion direction in which the convex portion protrudes from the liquid ejecting unit, and a portion of the wiping portion is preferably provided along the third direction, the portion being deformed according to the shape of the convex portion at the time of wiping the liquid at the first relative travel speed.

In this case, the convex portion is provided along the third direction, and a portion of the wiping portion, which is deformed according to the shape the convex portion at the time of wiping at the first relative travel speed is also provided along the third direction. In other words, when the wiping portion comes into contact with the convex portion at the time of wiping, the contact length between the convex portion and the wiping portion in the third direction can be long. Therefore, liquid attached to the convex portion can be moved to the flat portion efficiently.

In the liquid ejecting apparatus, the wiping portion preferably performs at least one of a wiping of the liquid ejecting unit at the first relative travel speed, and a wiping of the liquid ejecting unit at the second relative travel speed, multiple times.

In this case, at least one of the wiping of the liquid ejecting unit at the first relative travel speed and the wiping of the liquid ejecting unit at the second relative travel speed is performed multiple times, and the liquid remaining on the wiped surface can be reduced compared with a case where each of the wiping of the liquid ejecting unit at the first relative travel speed and the wiping of the liquid ejecting unit at the second relative travel speed is performed single time.

In the liquid ejecting apparatus, the convex portion preferably has water repelling properties. In this case, since the convex portion has water repelling properties, liquid attached to the convex portion can be moved easily to the flat portion when the wiping portion comes into contact with the convex portion.

In the liquid ejecting apparatus, the convex portion is preferably formed along the first direction. In this case, since the nozzle row and the convex portion are formed along the first direction, the shape of the wiping portion with respect to each of nozzles configuring the nozzle row can be uniform even after the wiping portion is deformed while wiping the convex portion.

In the liquid ejecting apparatus, a distance from a leading edge of the wiping portion to the apex of the convex portion is preferably equal or less than ten times the distance from the flat portion to an apex of the convex portion.

Liquid is likely to remain when wiping is performed with a portion close to the base of the wiping portion rather than with a portion close to the leading edge of the wiping portion. In this case, wiping performance with respect to the convex portion can be ensured since the distance from the leading edge of the wiping portion to the apex of the convex portion in the protrusion direction is equal to or less than ten times the distance from the flat portion to the apex of the convex portion.

According to another aspect of the invention, there is provided a wiping method of a liquid ejecting apparatus including a liquid ejecting unit that has a nozzle row configured to have a plurality of nozzles lined up along a first direction, and ejects liquid through the nozzles configuring the nozzle row, and a wiping portion that moves relative to the liquid ejecting unit in a second direction intersecting the first direction such that the liquid ejecting unit is wiped, in which the liquid ejecting unit includes a plurality of nozzle rows configured to have a space therebetween in the second direction, a convex portion placed between the nozzle rows in the second direction, and flat portions placed at both sides of the convex portion in the first direction, the method including: wiping the liquid ejecting unit with the wiping portion at a first relative travel speed to collect liquid attached to the liquid ejecting unit to the flat portion; and wiping the liquid ejecting unit with the wiping portion at a second relative travel speed faster than the first relative travel speed to move liquid attached to the flat portion, after the wiping at the first relative traveling speed.

In this case, the same effect as the liquid ejecting apparatus can be obtained. In the wiping method, at least one of the wiping at the first relative traveling speed and the wiping at the second relative traveling speed is preferably performed multiple times.

In this case, at least one of the wiping at the first relative travel speed and the wiping at the second relative travel speed is performed multiple times, and the liquid remaining on the wiped surface can be reduced compared with a case where each of the wiping at the first relative travel speed and the wiping of the liquid ejecting unit at the second relative travel speed is performed single time.

### BRIEF DESCRIPTION OF THE DRAWINGS

The invention will be described with reference to the accompanying drawings, wherein like numbers reference like elements.

FIG. 1 is a sectional view schematically illustrating the configuration of the liquid ejecting apparatus of an embodiment.

FIG. 2 is a schematic view illustrating a surface to be wiped of the liquid ejecting unit and a wiper.

FIG. 3 is a schematic sectional view of the liquid ejecting unit and the wiper.

FIG. 4 is a schematic sectional view of the liquid ejecting unit and a cap.

FIG. 5 is a schematic view of the wiper wiping the surface to be wiped.

FIG. 6 is a schematic view illustrating a state where the wiper has been moved to the convex portion.

FIG. 7 is a schematic sectional view illustrating a state where the wiper has traveled to the convex portion.

FIG. 8 is a schematic sectional view illustrating a state where the wiper is riding across the convex portion.

FIG. 9 is a schematic sectional view illustrating a state where the wiper which has completed riding across the convex portion.

FIG. 10 is a schematic view illustrating a state where the wiper moving at a first relative travel speed has passed through the convex portion.

FIG. 11 is a schematic view illustrating a state where the wiper moving at a second relative travel speed has passed through the convex portion.

### DESCRIPTION OF EXEMPLARY EMBODIMENTS

Hereinafter, an embodiment of the liquid ejecting apparatus is described in reference to drawings. An ink jet printer, as an example of liquid ejecting apparatus, prints onto a sheet, as an example of a target, by ejecting ink, as an example of liquid.

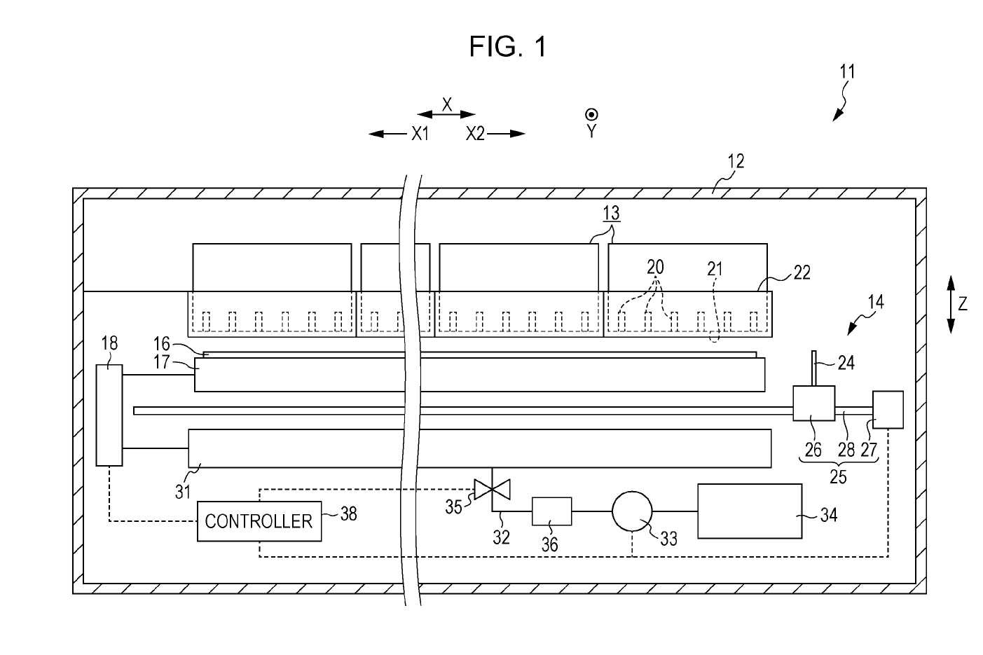

As illustrated in FIG. 1, a liquid ejecting apparatus 11 includes a casing unit 12, multiple liquid ejecting units 13 (for example, six) which are accommodated in the casing unit 12 and are arranged to be adjacent to each other in a parallel-arrangement direction X (left-right direction in FIG. 1), and a maintenance unit 14 which carries out maintenance for the liquid ejecting unit 13. In addition, the casing unit 12 accommodates a supporting frame 17 which supports a sheet 16, and a lifting/lowering mechanism 18 which lifts and lowers the supporting frame 17. In other words, the supporting frame 17 is provided to be able to travel between a supporting position (a position as shown in FIG. 1) where the supporting frame 17 supports a sheet 16 located close to the liquid ejecting unit 13 and a non-supporting position (not shown) where the supporting frame 17 is away from the liquid ejecting unit 13. The sheet 16 supported by the supporting frame 17 located at the supporting position is transported in a transport direction Y (a direction projecting from the surface of paper for the case of FIG. 1) which intersects (orthogonal to) the parallel-arrangement direction X by a transport mechanism (not shown).

Then, each liquid ejecting unit 13 has a cover 22 which covers a nozzle forming surface 21 where nozzles 20 are formed to eject liquid droplets. Because each of the liquid ejecting units 13 is configured to be the same as the other liquid ejecting units 13, configuration of one of the liquid ejecting units 13 will be described hereinafter while omitting the descriptions of configuration of other liquid ejecting units 13.

Moreover, the maintenance portion 14 includes a wiper 24 as an example of the wiping portion that wipes objects attached to the liquid ejecting unit 13, such as liquid and paper dust while traveling relative to the liquid ejecting unit 13 in the parallel-arrangement direction X, and a travel mechanism 25 which makes the wiper 24 travel relative to the liquid ejecting unit 13. The travel mechanism 25 has a wiper holder 26 that holds the base of the wiper 24, a driving mechanism 27 which drives the wiper 24 to travel together with the wiper holder 26, and a guide portion 28 which guides the wiper holder 26 when the wiper holder 26 travels. The guide portion 28 is extended along the parallel-arrangement direction X, and is able to travel in a lifting/lowering direction Z intersecting (orthogonal to) the parallel-arrangement direction X. In other words, the driving mechanism 27 drives the wiper 24 to travel in the lifting/lowering direction Z intersecting (orthogonal to) the transport direction Y by driving the guide portion 28 to travel between an upper position (not shown) and a lower position (position as shown in FIG. 1).

Furthermore, the wiper 24, which is made of an elastomer or the like, is elastically deformed when being in contact with the liquid ejecting unit 13. Then, the wiper 24 performs wiping of the liquid ejecting unit 13 by traveling in a state where in which the leading edge thereof is in contact with the liquid ejecting unit 13 at a predetermined contact pressure.

In other words, the driving mechanism 27 drives the wiper 24 to travel in a wiping direction X1 where the wiper 24 is away from the driving mechanism 27 in the state where the guide portion 28 is positioned at the upper position close to the liquid ejecting unit 13, so that the liquid ejecting unit 13 is wiped. Furthermore, the driving mechanism 27 drives the wiper 24 to travel in a returning direction X2 where the wiper 24 approaches the driving mechanism 27 in the state where in which the guide portion 28 is positioned at the lower position away from the liquid ejecting unit 13. The wiper 24, then, travels toward the driving mechanism 27 without being in contact with the liquid ejecting unit 13.

Furthermore, the maintenance unit 14 includes a cap 31 that covers a space to which the nozzles 20 face, when the cap 31 is in contact with the liquid ejecting unit 13; a waste liquid passage 32 of which one end is connected to the cap 31; and a depressurizing mechanism 33 depressurizing the space in the waste liquid passage 32, which is enclosed by the cap 31. Furthermore, the other end of the waste liquid passage 32 is connected to a waste liquid container 34. Moreover, in the waste liquid passage 32, a passage valve 35 which blocks the flow of fluid passing through the waste liquid passage 32 when the valve is closed is provided between the cap 31 and the depressurizing mechanism 33, and a pressure chamber 36 is provided between the passage valve 35 and the depressurizing mechanism 33.

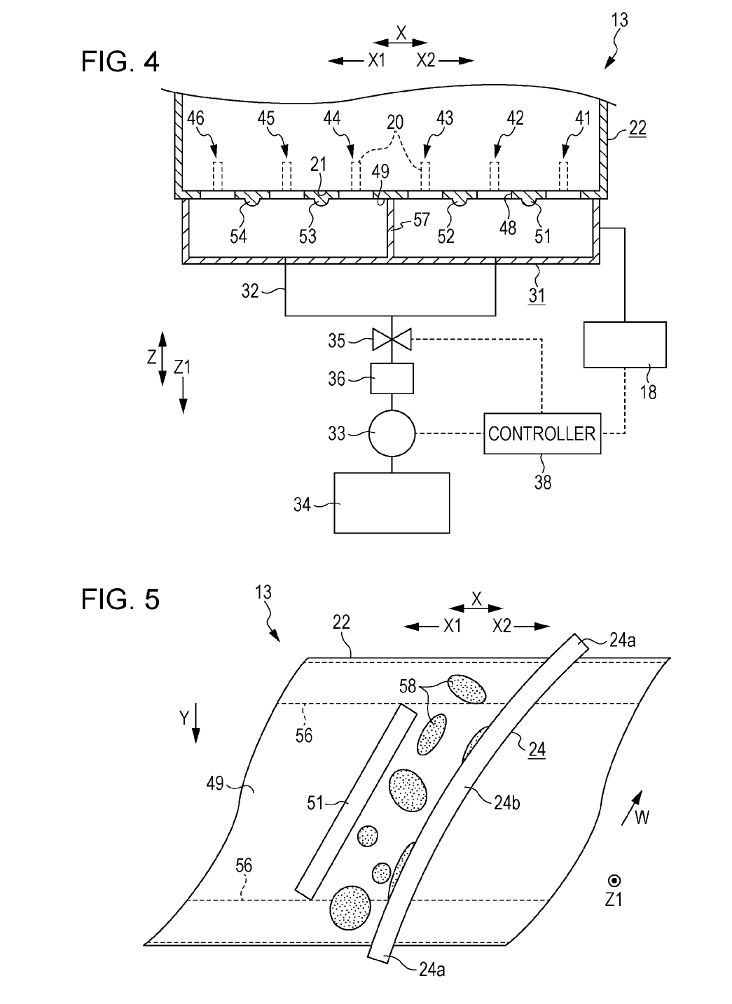

Furthermore, the cap 31 is provided to be able to be lifted and lowered between a contact position (a position illustrated in FIG. 4) where the cap 31 is in contact with the liquid ejecting unit 13 and a non-contact position (a position illustrated in FIG. 1) where the cap 31 is separated from the liquid ejecting unit 13 by the lifting/lowering mechanism 18 lifting and lowering the supporting frame 17. In other words, the cap 31 is positioned at the non-contact position when the supporting frame 17 is positioned at the supporting position. Then, the cap 31 is lifted from the non-contact position and positioned at the contact position when the supporting frame 17 travels from the supporting position and positioned at the non-supporting position. Furthermore, in the present embodiment, making the cap 31 come into contact with the liquid ejecting unit 13 and sealing the space to which the nozzles 20 face is called “capping”.

Then, the liquid ejecting apparatus 11 includes a controller 38 which controls operation of the lifting/lowering mechanism 18, the driving mechanism 27, the depressurizing mechanism 33, and the passage valve 35; and carries out maintenance of the liquid ejecting unit 13 based on control of the controller 38.

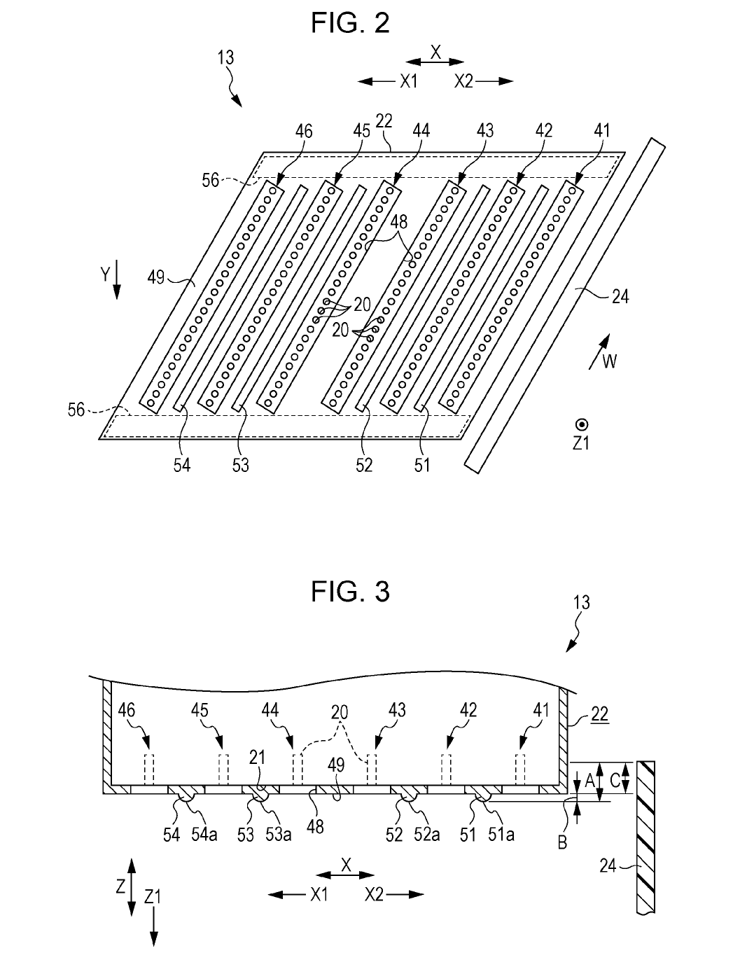

As shown in FIG. 2, the liquid ejecting unit 13 has nozzle rows 41 to 46, a plurality of nozzles 20 being formed by lining up nozzles as one row along an extension direction W, an example of a first direction; and performs printing by ejecting liquid through each of the nozzles 20 configuring the nozzle rows 41 to 46. Furthermore, a plurality of the nozzle rows 41 to 46 (six in the present embodiment) are formed spaced apart from each other in a wiping direction X1, as an example of a second direction intersecting the extension direction W.

As shown in FIGS. 2 and 3, opening portions 48, of which the number is the same as the number of the nozzle rows 41 to 46 (six in the present embodiment) are formed at portions of the cover 22 corresponding to each of the of the nozzle rows 41 to 46, respectively; and each of the nozzle rows 41 to 46 is exposed through each of the opening portions 48. Furthermore, a plurality of convex portions 51 to 54 (for example, four in the present embodiment) are formed on a wiping target surface 49 and provided between the opening portions 48 in the parallel-arrangement direction X, the nozzle surface being on one side of the cover 22 opposite to the nozzle forming surface 21, and is wiped by the wiper 24.

In other words, the convex portions 51 to 54 are located between nozzle rows 41 to 46 in the wiping direction X1, and are formed along the extension direction W as an example of a third direction intersecting the protrusion direction Z1. More specifically, the first convex portion 51 is formed between the first nozzle row 41 and the second nozzle row 42; the second convex portion 52, between the second nozzle row 42 and the third nozzle row 43; the third convex portion 53, between the fourth nozzle row 44 and the fifth nozzle row 45; and the fourth convex portion 54, between the fifth nozzle row 45 and the sixth nozzle row 46.

In other words, the nozzle rows 41 to 46 and the convex portions 51 to 54 are formed in substantially parallel to each other. Furthermore, the wiper 24 has a leading edge which wipes the wiping target surface 49 along the extension direction W and is provided in substantially parallel with the nozzle rows 41 to 46 and the convex portions 51 to 54. Furthermore, in the extension direction W, the length of the wiper 24 is a little longer than the length of the liquid ejecting unit 13 so that it is possible to wipe the entirety of the wiping target surface 49 by the wiper 24 traveling in the wiping direction X1.

Moreover, each of the convex portions 51 to 54 on the wiping target surface 49 of the cover 22 does not cover the entire wiping target surface 49 in the extension direction W. The wiping target surface 49 of the cover 22 has a flat portion 56 provided at each of both ends of the convex portions 51 to 54 in the extension direction W. In other words, the convex portions 51 to 54 are protruded with respect to the flat portion 56, and protruded from the wiping target surface 49 in a protrusion direction Z1. Furthermore, the protrusion direction Z1 is a direction from the wiping target surface 49 toward the supporting frame 17 positioned at the supporting position; and the protrusion direction Z1 is a downward direction in the FIG. 3. Moreover, a surface of each of the of the convex portions 51 to 54 is subject to a water repelling treatment to have water repelling properties.

As illustrated in FIG. 3, in the protrusion direction Z1 in which the convex portions 51 to 54 are protruded from the liquid ejecting unit 13, an overlap amount A is equal to or less than 10 times a protrusion amount B, the overlap amount A being a distance from the leading edge of the wiper 24 to apexes 51a to 54a of the convex portions 51 to 54, and the protrusion amount B being a distance from the flat portion 56 (the wiping target surface 49) to the apexes 51a to 54a of the convex portions 51 to 54.

Furthermore, the value, 10 times, is derived from test results shown in Table 1 and Table 2, and represents a the positional relationship when the wiper 24 wipes the liquid ejecting unit 13 with the guide portion 28 positioned at the upper position. The thickness of the cover 22 in the protrusion direction Z1 in the present embodiment is sufficiently small when compared with the protrusion amount B of the convex portions 51 to 54 (for example, about one-fifth), so that the nozzle forming surface 21, which is exposed from the opening portions 48, can be wiped similar to the wiping target surface 49 even if the thickness of cover 22 is ignored.

TABLE 1

| Protrusion Amount (mm) | 0.1 | 0.2 | 0.3 | 0.4 | 0.5 |
|---|---|---|---|---|---|
| Result | D | C | B | C | D |

Table 1 shows results of printing when the protrusion amount B of the convex portions 51 to 54 in a protrusion direction Z1 were changed. When the protrusion amount B of the convex portions 51 to 54 was equal to or less than 0.1 mm, the liquid deformed the sheet 16 onto which the liquid was ejected through the nozzles 20 and was attached; the deformed sheet came into contact with the wiping target surface 49; and the liquid and other things attached to the wiping target surface 49 were attached to the sheet 16. In other words, the effects expected occur in the convex portions 51 to 54, for example, suppressing contact between the deformed sheet 16 and the wiping target surface 49, were not obtained. On the other hand, when the protrusion amount B of the convex portions 51 to 54 was equal to or greater than 0.5 mm, the gaps between the apexes 51a to 54a of the convex portions 51 to 54 and the supporting frame 17 became narrow excessively, and caused trouble in transporting the sheet 16. Therefore, the protrusion amount B of the convex portions 51 to 54 is greater than 0.1 mm and less than 0.5 mm, for example, preferably in the range of 0.2 mm to 0.4 mm, and more preferably 0.3 mm.

TABLE 2

| | Interference Amount (mm) | | | | | | | | |
|---|---|---|---|---|---|---|---|---|---|
| | 0.8 | 0.9 | 1.0 | 1.1 | 1.2 | 1.3 | 1.4 | 1.5 | 1.6 |
| Result | D | C | C | B | B | B | C | C | D |

Moreover, Table 2 shows results of wiping when interference amount C, a distance from the wiping target surface 49 to the leading edge of the wiper 24 in the protrusion direction Z1, is changed. That is, when the interference amount C of wiper 24 was equal to or less than 0.8 mm, the wiper 24 was not able to be in contact with the liquid ejecting unit 13 with enough contact pressure, and liquid remained on the wiping target surface 49. On the other hand, when the interference amount C of the wiper 24 was equal to or greater than 1.6 mm, the wiper 24 was in contact with the wiping target surface 49 with a portion not close to the leading edge but close to the base so that liquid remained on the wiping target surface 49. Therefore, the interference amount C of the wiper 24 is greater than 0.8 mm and less than 1.6 mm; for example, preferably equal to or greater than 0.9 mm and equal to or less than 1.5 mm, and more preferably equal to or greater than 1.1 mm and equal to or less than 1.3 mm.

Preferably, the protrusion amount of the convex portions 51 to 54 is in the range of 0.2 mm to 0.4 mm, interference amount C of the wiper 24 are in the range of 0.9 mm to 1.5 mm. From this, the preferable overlap amount A, the distance from the apexes 51a to 54a of the convex portions 51 to 54 to a the leading edge of the wiper 24, is in the range of 1.1 mm to 1.9 mm, the values being obtained by adding the maximum and the minimum values of the preferable protrusion amount to the maximum and the minimum values of the preferable interference amount, respectively. Furthermore, the maximum value of the interference amount C, 1.9 mm, is 9.5 times the minimum value of the protrusion amount B of the convex portions 51 to 54, 0.2 mm. Therefore, a relationship that the overlap amount A of the wiper 24 is equal to or less than ten times the protrusion amount of the convex portions 51 to 54, is derived.

As shown in FIG. 4, the cap 31 is partitioned by a partition wall 57, so that each partitioned space covers three rows out of the nozzle rows 41 to 46. Then, when the cap 31 performs capping the liquid ejecting unit 13 positioned at the contact position, the partition wall 57 comes into contact with the area of the wiping target surface 49 between the third nozzle row 43 and the fourth nozzle row 44 where none of the convex portions 51 to 54 are formed. Moreover, each space partitioned by the partition wall 57 of the cap 31 is connected to each cap side end of a branch branched from the waste liquid passage 32, respectively.

Next, the operation of the liquid ejecting apparatus 11 configured as the above description will be described with regard to the maintenance unit 14 performing maintenance operations of the liquid ejecting unit 13. Furthermore, maintenance operations are performed when a predetermined amount of time elapses after previous maintenance is performed, or when a user inputs a maintenance command. In the embodiment, maintenance operations in a case where suction cleaning, preliminary wiping, low speed wiping, and high speed wiping are performed in an order will be described.

As shown in FIG. 4, the controller 38 drives the lifting/lowering mechanism 18 to make the supporting frame 17 travel to the non-supporting position; performs capping of the liquid ejecting unit 13 by making the cap 31 travel to the contact position. Subsequently, the controller 38 closes the passage valve 35, and drives the a depressurizing mechanism 33. And then, negative pressure is accumulated in the pressure chamber 36. And then, the controller 38 opens the passage valve 35 when enough negative pressure has accumulated in the pressure chamber 36. And then, pressure in the cap 31 is reduced so that liquid is discharged forcefully through the nozzles 20. The amount of discharged liquid needed for the suction cleaning can be reduced by accumulating negative pressure in advance and changing the pressure in the cap 31 suddenly; lots of bubbles, however, are generated in the discharged liquid.

At that time, the controller 38 waits for a certain amount of time (a queuing time), which is preset in the state where the cap 31 performs capping of the liquid ejecting unit 13. And then, when bubbles in the cap 31 are reduced as the queuing time is passed, the controller 38 opens an air vent valve (not shown); drives the depressurizing mechanism 33; and sends the liquid remaining in the cap 31 to the waste liquid container 34. After that, the controller 38 makes the cap 31 travel to the non-contact position by driving the lifting/lowering mechanism 18.

In a case where such suction cleaning is performed, even after the queuing time elapses, bubbles may be attached to the liquid ejecting unit 13 in some cases. Therefore, preliminary wiping is performed with a small interference amount C between the liquid ejecting unit 13 and the wiper 24.

In other words, the controller 38 drives the driving mechanism 27 so as to position the guide portion 28 between the upper position and the lower position. More specifically, the controller 38 makes the guide portion 28 travel so that interference amount C is in the range of 0 mm to 0.8 mm. In this state, the controller 38 drives the driving mechanism 27, so that the wiper 24 travels in the wiping direction X1. As a result, the contact pressure between the wiper 24 and the liquid ejecting unit 13 when the wiper 24 is deformed being in contact with the liquid ejecting unit 13 becomes small, and the liquid ejecting unit 13 can be wiped while suppressing fly-off of the liquid to surrounding area. In other words, bubbles are removed being in contact with the wiper 24, but liquid remains on the wiping target surface 49. Furthermore, a travel speed of the wiper 24 traveling in the wiping direction X1 can be set arbitrarily. Once all the liquid ejecting units 13 are wiped, the controller 38 makes the guide portion 28 travel to the lower position by driving the driving mechanism 27, and then makes the wiper 24 travel in the returning direction X2.

Subsequently, the controller 38 performs low speed wiping. In other words, the controller 38 places the guide portion 28 at the upper position by driving the driving mechanism 27, and then makes the wiper 24 travel in the wiping direction X1 relative to the liquid ejecting units 13 at the first travel speed as the first relative travel speed (the first wiping operation).

Further, in FIGS. 5 to 11, illustration for the nozzle rows 41 to 46 and the opening portions 48 are omitted to describe a relationship between the convex portions 51 to 54 and the wiper 24 more easily; and only one convex portion (the first convex portion) 51, the wiper 24, and liquid 58 attached to the wiping target surface 49 are illustrated with the wiping target surface 49 enlarged. Also, because the shape of the wiper 24 passing through each one of the convex portions 51 to 54 is the same as the shapes of the wiper 24 passing through other convex portions, the relationship between the first convex portion 51 and the wiper 24 is described while description of relationships between other convex portions and the wiper 24 are omitted.

As shown in FIG. 2, the leading edge of the wiper 24 which is deformable according to the shape of the convex portion 51 when wiping the first convex portion 51 at the first travel speed is provided along the extension direction W.

And, as shown in FIG. 5, when the wiper 24 being in contact with the wiping target surface 49 travels in the wiping direction X1, both ends 24a of the wiper 24 in the extension direction W are left behind the center 24b, so that the wiper 24 travels while maintaining a curved shape. And so, liquid 58 and the like attached to the wiping target surface 49 are collected by the wiper 24.

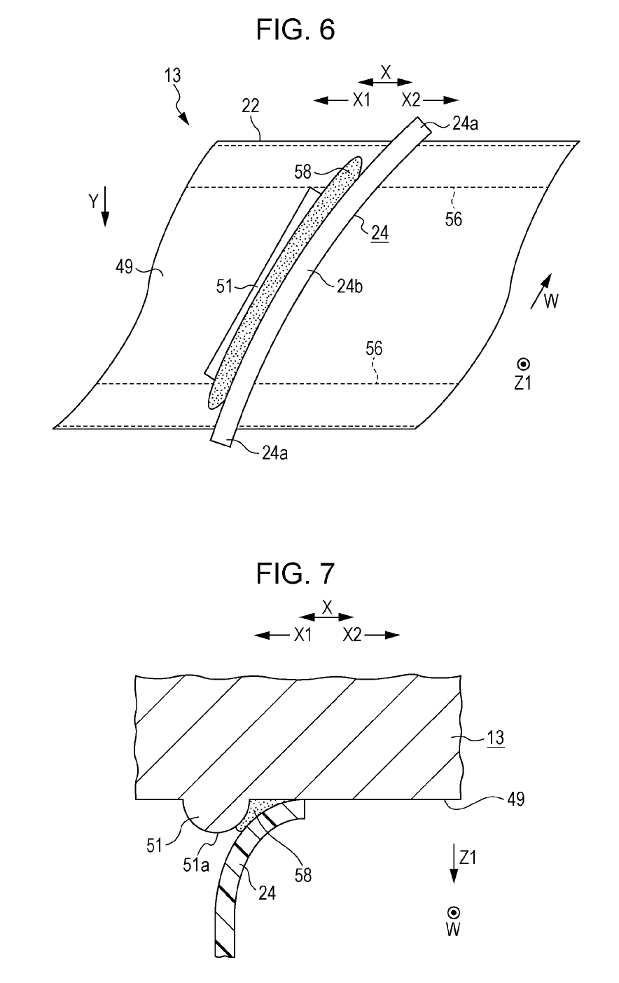

Further, as shown in FIGS. 6 and 7, the liquid 58 once attached to the wiping target surface 49 and then collected by the wiper 24 is pushed into the space between the wiper 24 and the convex portion 51. At that time, a center 24b of the wiper 24 in the extension direction W comes into contact with the convex portion 51 before the both ends 24a of the wiper 24 come into contact with the convex portion 51; and then, the both ends 24a come into contact with the convex portion 51 progressively. Therefore, the liquid 58 is moved toward the flat portion 56 being pushed toward the both ends 24a.

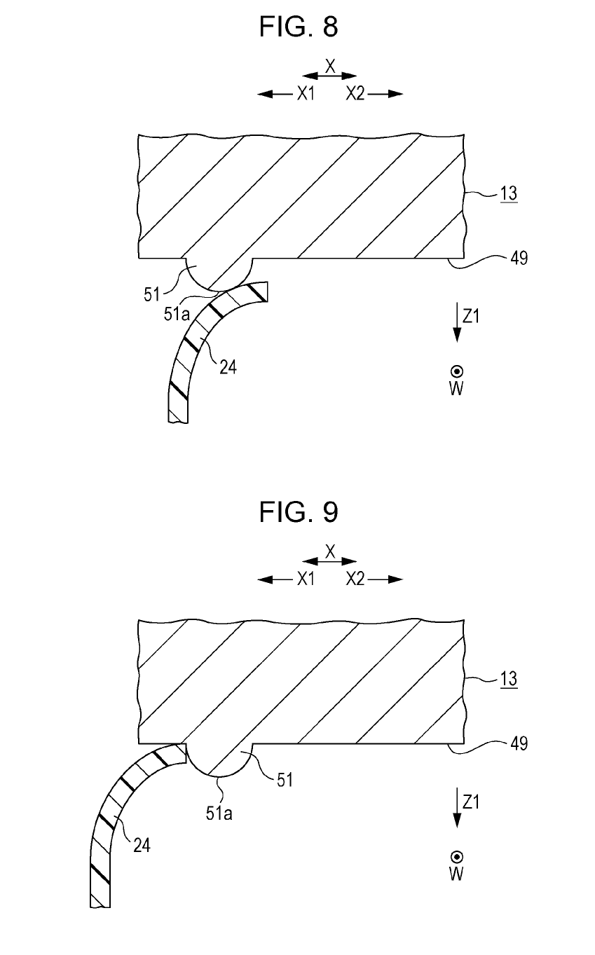

Moreover, as shown in FIG. 8, when the wiper 24 passes through the convex portion 51, the wiper 24 is deformed according to the shape of the convex portion 51, wipes the surface of the convex portion 51, and rides across the convex portion 51.

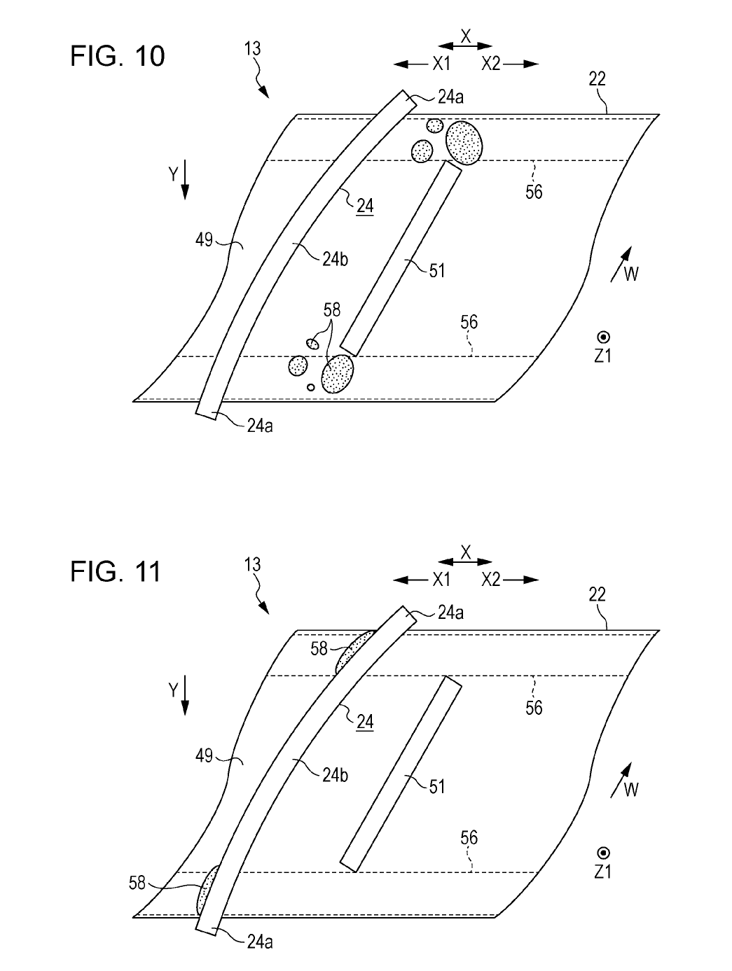

Further, as shown in FIGS. 9 and 10, the liquid 58 is hit by the wiper 24 returning its original shape after riding across the convex portion 51, in some cases. But the liquid 58 is on the flat portion 56 at that time, and thus the liquid 58 is scattered in the flat portion 56 or near the flat portion 56 even when the wiper 24 hits the liquid 58.

TABLE 3

First Travel Speed (in/s)

| | 0.4 | 0.5 | 0.6 | 0.7 | 0.8 | 0.9 | 1.0 | 1.1 |
|---|---|---|---|---|---|---|---|---|
| Result | D | C | C | B | B | C | C | D |

Further, as shown in Table 3, when the first travel speed was lower than 0.4 in/s (equivalent to 1.016 cm/s), the liquid 58 attached to the wiping target surface 49 of the liquid ejecting unit 13 wiped later than another liquid ejecting units 13 was gradually thickened, the liquid ejecting units 13 being parallel with another liquid ejecting unit 13 in the parallel-arrangement direction X; and the liquid 58 was not moved to the flat portion 56 in a favorable manner. On the other hand, when the first travel speed is higher than 1.1 in/s, the wiper 24 passed through the convex portion 51 before the liquid 58 moved far enough toward the flat portion 56; and the liquid 58 remained at a location away from the flat portion 56. Based on the test results, the first travel speed is preferably in the range of 0.5 in/s to 1.0 in/s, and more preferably 0.7 in/s to 0.8 in/s.

When the wiper 24 travels to a side opposite to the side where the driving mechanism 27 is provided, and wipes the entire liquid ejecting units 13, the controller 38 drives the driving mechanism 27 to make the guide portion 28 travel to the lower position, and makes the wiper 24 travel along the guide portion 28 positioned at the lower position in the returning direction X2. And when the wiper 24 returns to a side where the driving mechanism 27 is provided, the controller 38 controls the driving of the driving mechanism 27 to make the guide portion 28 travel to the upper position; and makes the wiper 24 travel along the guide portion 28 positioned at the upper position in the wiping direction X1 at the first travel speed again (a first wiping operation). In other words, according to the present embodiment, the wiper 24 performs the first wiping operation more than once, which wipes the liquid ejecting unit 13 at the first travel speed.

The wiper 24 collects liquid attached to the liquid ejecting unit 13, and sends the collected liquid to the flat portion 56 by wiping the liquid ejecting unit 13 at the first travel speed multiple times, and then wipes the liquid ejecting unit 13 at a second travel speed as the second relative travel speed higher than the first relative travel speed to move the liquid 58 attached to the flat portion 56.

In other words, when the wiper 24 wipes all the liquid ejecting units 13 by travelling at the first travel speed, the controller 38 drives the driving mechanism 27 so that guide portion 28 is located at the lower position, and makes the wiper 24 travel in the returning direction X2. Then, when the wiper 24 returns to the side where the driving mechanism 27 is provided, the controller 38 drives the driving mechanism 27 so that the guide portion 28 travels to the upper position. Further, the controller 38 drives the driving mechanism 27 so that the wiper 24 travels in the wiping direction X1, along the guide portion 28 positioned at the upper position, at the second travel speed higher than the first travel speed (the second wiping operation).

As the wiper 24 wipes the wiping target surface 49, the higher the travel speed of the wiper 24, more amount of liquid 58 can be moved. In other words, when the travel speed of the wiper 24 is low, only little amount of liquid can be moved to the flat portion 56 by the wiper 24 from a space between the convex portion 51 and the wiper 24, so that liquid remains on the flat portion 56. On the other hand, when the travel speed of the wiper 24 is high, the wiper 24 passes through the convex portion 51 before liquid is moved to the flat portion 56 and liquid is scattered on a place away from the flat portion 56; but liquid attached to the flat portion 56 is moved by the wiper 24.

Therefore, as shown in FIG. 11, as the wiper 24 travels at the second travel speed in the wiping direction X1, liquid 58 attached to the flat portion 56 and not wiped off during the travel at the first travel speed is moved together with the wiper 24.

TABLE 4

| | Second Travel Speed (in/s) | | | | | | |
|---|---|---|---|---|---|---|---|
| | 2.7 | 2.8 | 2.9 | 3.0 | 3.1 | 3.2 | 3.3 |
| Result | D | D | D | C | C | B | B |

Further, as shown in Table 4, when the second travel speed was lower than 2.9 in/s, liquid attached to the flat portion 56 and a periphery of the flat portion 56 was not sufficiently moved so that liquid remained on the wiping target surface 49. Based on the test results, the second travel speed is preferably equal to or greater than 3.0 in/s, and more preferably equal to or greater than 3.2 in/s. Moreover, since the first travel speed is preferably in the range of 0.5 in/s to 1.0 in/s, the second travel speed is preferably equal to or greater than three times the first travel speed.

According to the above embodiments, the following effects can be obtained.

(1) In the case of wiping the liquid ejecting unit 13 with the wiper 24 traveling relative to the liquid ejecting unit 13, when a relative travel speed of the wiper 24 relative to the liquid ejecting unit 13 is low, spaces between the nozzle rows 41 to 46 and the convex portions 51 to 54 can be wiped efficiently by the wiper 24, but liquid is likely to remain in the flat portion 56. On the other hand, when the relative travel speed of the wiper 24 relative to the liquid ejecting unit 13 is high, liquid is likely to remain between the nozzle rows 41 to 46 and the convex portions 51 to 54, but the flat portion 56 can be wiped efficiently by the wiper 24. It is considered that there is enough time for liquid to be moved to the flat portion 56 when the relative travel speed of the wiper 24 relative to the liquid ejecting unit 13 is low, the liquid being sandwiched between the wiper 24 and the convex portions 51 to 54 at the time when the wiper 24 is in contact with the convex portions 51 to 54; and on the other hand, the wiper 24 passes through the convex portions 51 to 54 before the liquid is moved to the flat portion 56 when relative travel speed of the wiper 24 relative to the liquid ejecting unit 13 is high. Moreover, the amount of liquid 58 able to be moved by the wiper 24 is changed depending on the relative travel speed of the wiper 24 relative to the liquid ejecting unit 13; the amount of liquid that can be moved in the case of a high travel speed is greater than that in the case of a low travel speed. Therefore, it is considered that liquid can be moved from spaces between the nozzle rows 41 to 46 and the convex portions 51 to 54 to the flat portion 56 in the case of a low travel speed; liquid 58, however, is likely to remain because only small amount of liquid is moved from the flat portion 56. Accordingly, the wiping of the liquid ejecting unit 13 at the first travel speed, which is relatively low speed, is performed first to move the liquid 58 attached in the spaces between the nozzle rows 41 to 46 and the convex portions 51 to 54 of the liquid ejecting unit 13 to the flat portion 56, and then the wiping of the liquid ejecting unit 13 at the second relative travel speed, which is relatively high speed, is performed to wipe the liquid 58 remaining in the flat portion 56, whereby both the convex portions 51 to 54 and the flat portion 56 can be wiped efficiently. Therefore, it is not necessary to absorb liquid by the wiper 24, the wiper 24 can be made of an elastic body such as an elastomer and a wiping of the liquid ejecting portion which has the convex portion can be performed efficiently.

(2) The convex portions 51 to 54 are provided along the parallel-arrangement direction W, and a portion of the wiper 24, which is deformed according to the shape of the convex portions 51 to 54 at the time of wiping at the first travel speed is also provided along the parallel-arrangement direction W. In other words, when the wiper 24 comes into contact with the convex portions 51 to 54 at the time of wiping, the contact length between the convex portions 51 to 54 and the wiper 24 in the parallel-arrangement direction W can be long. Therefore, liquid 58 attached to the convex portions 51 to 54 can be moved to the flat portion 56 efficiently.

(3) At least one of the wiping of the liquid ejecting unit 13 at the first travel speed and the wiping of liquid ejecting unit 13 at the second travel speed is performed multiple times, and the liquid remaining on the wiped surface can be reduced compared with a case where each of the wiping of the liquid ejecting unit 13 at the first travel speed and the wiping of the liquid ejecting unit 13 at the second travel speed is performed single time.

In other words, even when a larger amount of liquid 58 is attached to the convex portions 51 to 54 and the wiping target surface 49, so that single wiping with the wiper 24 is not enough to wipe the liquid; the wiping with the wiper 24 is performed multiple times and the liquid attached the convex portions 51 to 54 and the wiping target surface 49 can be reduced.

(4) Since the convex portions 51 to 54 have water repelling properties, liquid 58 attached to the convex portions 51 to 54 can be moved easily to the flat portion 56 when the wiper 24 comes into contact with the convex portions 51 to 54.

(5) Since the nozzle rows 41 to 46 and the convex portions 51 to 54 are formed along the extension direction W, the shape of the wiper 24 with respect to each of nozzles 20 configuring the nozzle rows 41 to 46 can be uniform even after the wiping portion is deformed while wiping the convex portions 51 to 54.

(6) Liquid is likely to remain when wiping is performed with a portion close to the base of the wiper 24 rather than with a portion close to the leading edge of the wiper 24. Accordingly, wiping performance with respect to the convex portions 51 to 54 can be ensured since the overlap amount A, the distance from the leading edge of the wiper 24 to the apexes 51a to 54a of the convex portions 51 to 54 in the protrusion direction Z1, is equal to or less than ten times the protrusion amount B, the distance from the flat portion 56 to the apexes 51a to 54a of the convex portions 51 to 54.

(7) At least one of the first wiping operation and the second wiping operation is performed multiple times, and the liquid remaining on the wiped surface can be reduced compared with a case where each of the first wiping operation and the second wiping operation is performed single time.

Furthermore, following modifications on the above embodiment may be made.

In the above embodiment, the convex portions 51 to 54 may be formed by being drawn in the drawing process. Moreover, the convex portions 51 to 54 may be formed by adhering or fusing a separate member formed separately from the cover 22. Furthermore, the convex portions 51 to 54 can be formed by attaching a material which is solidified when it is cooled, such as metal, or a resin which can be hardened by heat, ultra-violet ray, or the like to the cover 22.

In the above exemplary embodiment, the convex portions 51 to 54 may be formed by laying multiple semispherical convex portions in the extension direction W. Furthermore, the shape of the convex portions 51 to 54 may be a semi-cylindrical shape, a prism shape, a semi-elliptical shape, or the like. In addition, the convex portions 51 to 54 may have different protrusion amounts B. It is preferable that the largest protrusion amount is in the range of 0.2 mm to 0.4 mm if the convex portions 51 to 54 have different protrusion amounts B.

In the above embodiment, the number of convex portions 51 to 54 formed in the liquid ejecting unit 13 is may be changed to an arbitrary number. For example, only the first convex portion 51 may be formed rather than being formed with other convex portions 52 to 54, the first convex portion 51 to the fourth convex portion 54 as well. Moreover, one convex portion may be formed between the third nozzle row 43 and the fourth nozzle row 44 of the liquid ejecting unit 13. Also, multiple convex portions can be formed between nozzle rows adjacent to each other in the wiping direction X1.

In the above embodiment, the number of the liquid ejecting units 13 may be one. Moreover, for the liquid ejecting apparatus 11 in which the liquid ejecting unit 13 travels back and forth along the parallel-arrangement direction X, relative movement between the wiper 24 and the liquid ejecting apparatus 11 may be achieved by the making liquid ejecting unit 13 travel.

In the above embodiment, in the middle of wiping of the liquid ejecting unit 13 with the wiper 24, the wiper 24 may travel in the lifting/lowering direction Z. For example, wiping may be performed at the optimum contact positions at the time of wiping the convex portions 51 to 54 with the wiper 24 and at the time of wiping the space between convex portions 51 to 54.

In the present embodiment, a travel speed of the wiper 24 may be changed at the time of wiping the convex portions 51 to 54 and at the time of wiping the space between the convex portions 51 to 54.

In the present embodiment, the guide portion 28 may be fixedly provided, and the liquid ejecting unit 13 may be lifted and lowered.

In the present embodiment, the wiper 24 may be in contact with the liquid injecting unit 13 to wipe the wiping target surface 49 even when traveling in the returning direction X2.

In the present embodiment, the passage valve 35 and the pressure chamber 36 may not be provided. Instead, liquid may be discharged from the nozzles 20 by applying pressure depressurized by a depressurizing mechanism 33 directly to the cap 31. In this case, compared to the case where liquid is discharged by the accumulated negative pressure, liquid is discharged not forcefully. Accordingly, a large amount of liquid needs to be discharged during the suction cleaning, but liquid discharged to the cap 31 contains less bubbles. Hence, wiping at a low speed (the first wiping operation) and then wiping at a high speed (the second wiping operation) may be performed without performing preliminary wiping. Moreover, the wiping at a low speed and the wiping at a high speed may be performed regardless of performing the suction cleaning.

In the present embodiment, the number of times of performing the first and the second wiping operations may be changed, the first and the second wiping operations being operations of wiping the liquid ejecting unit 13 at the first and the second travel speeds, respectively. For example, the first wiping operation may be performed once, and then the second wiping operation may be performed once; or the first wiping operation and the second wiping operation may be repeatedly performed while being alternated. Moreover, the first wiping operation may be performed once and then the second wiping operation may be performed more than once. Further, the first wiping operation may be performed more than once, and then the second wiping operation may be performed more than once. Further, when the first and the second wiping operations are performed more than once, each of the first travel speeds of the first wiping operation may be different from other travel speeds of the first wiping operation and each of the second travel speeds of the second wiping operation may be different from other travel speeds of the second wiping operation. For example, after the first wiping operation is performed at the first travel speed of 0.5 in/s, another first wiping operation may be performed at the travel speed of 0.7 in/s.

In the present embodiment, the overlap amount A between the wiper 24 and the convex portions 51 to 54 can be more than 10 times the protrusion amount B. For example, deformability of the wiper 24 is varied by the shape, thickness, material, and the like. Because of that, the relationship between the overlap amount A and the protrusion amount B may be changed depending on the wiper 24 to be used.

In the present embodiment, the convex portions 51 to 54 may be formed along the direction intersecting the extension direction W along which the nozzle rows 41 to 46 are formed. In other words, the first direction and the third direction may be different. Moreover, the convex portions 51 to 54 do not need to be made parallel with each other, and the convex portions 51 to 54 may be respectively formed along directions intersecting each other.

In the present embodiment, the convex portions 51 to 54 may have water repelling properties.

In the present embodiment, the wiper 24 may be provided so that the leading edge of the wiper 24 deformable at the time of wiping the liquid ejecting unit 13 extends along the direction different from the extension direction W in which the convex portions 51 to 54 are formed. For example, the leading edge of the wiper 24 which is deformable at the time of wiping the liquid ejecting unit 13 may be inclined at a predetermined angle with respect to the extension direction W in which the convex portions 51 to 54 are formed. In this case, since the contact region of the wiper 24 can be gradually increased from one end to the other end of the convex portions 51 to 54 when the low speed wiping is performed, movement of the liquid 58 can be concentrated on only one flat portion 56 of two the flat portions 56.

In the present exemplary embodiment, the liquid ejecting apparatus may eject or discharge liquid other than ink. Further, a state of the liquid discharged from the liquid ejecting apparatus as small droplets may be a granular shape, a teardrop shape, and a shape that resembles pulling a thread from a string, or the like. Moreover, the liquid described herein may be any material as long as the material ejected from the liquid ejecting apparatus. For example, the liquid includes materials in liquid state, high viscous or low viscous liquid state body, sol, gel, other inorganic solvent, organic solvent, solution, liquid resin, and fluid state body such as liquid metal (molten metal). Moreover, the liquid is not limited to liquid as the state of a substance; the liquid includes materials obtained by dissolving, dispersing or mixing powder of a functional material with a solvent, the powder of a functional material being composed of solid matters such as pigments and metal particles. Typical examples of liquid include ink as described in the present exemplary embodiment herein, liquid crystal, or the like. Generally, ink includes water-soluble ink and oil-soluble ink along with various liquid compositions such as gel type ink, and hot melt ink. Specific examples of the liquid ejecting apparatus include a liquid ejecting apparatus ejecting liquid containing dispersed or dissolved materials such as an electrode material and a color material used for manufacturing a liquid crystal display, an electro luminescence (EL) display, surface emission display, a color filters or the like. Moreover, the liquid ejecting apparatus includes a liquid ejecting apparatus ejecting bioorganic matter used in manufacturing biochips, a liquid ejecting apparatus that ejects liquid to be used as a specimen for a precision pipette, a printing apparatus, a microdispenser, and so on.

The entire disclosure of Japanese Patent Application No. 2014-229822, filed Nov. 12, 2014 is expressly incorporated by reference herein.

What is claimed is:

1. A liquid ejecting apparatus comprising:
a liquid ejecting unit that has a nozzle row configured to have a plurality of nozzles lined up along a first direction, and ejects liquid through the nozzles configuring the nozzle row; and
a wiping portion that moves relative to the liquid ejecting unit in a second direction intersecting the first direction such that the liquid ejecting unit is wiped,
wherein the liquid ejecting unit includes
a plurality of nozzle rows configured to have space therebetween in the second direction,
a convex portion placed between the nozzle rows in the second direction, and
flat portions placed at both sides of the convex portion in the first direction, and
wherein the wiping portion wipes the liquid ejecting unit at a first relative travel speed to collect liquid attached to the liquid ejecting unit to the flat portion, and then wipes the liquid ejecting unit at a second relative travel speed faster than the first relative travel speed to move liquid attached to the flat portion.

2. The liquid ejecting apparatus according to claim 1,
wherein the convex portion is provided along a third direction intersecting a protrusion direction in which the convex portion protrudes from the liquid ejecting unit, and
wherein a portion of the wiping portion is provided along the third direction, the portion being deformed according to the shape of the convex portion at the time of wiping the liquid at the first relative travel speed.

3. The liquid ejecting apparatus according to claim 1, wherein the wiping portion performs at least one of a wiping of the liquid ejecting unit at the first relative travel speed, and a wiping of the liquid ejecting unit at the second relative travel speed, multiple times.

4. The liquid ejecting apparatus according to claim 1, wherein the convex portion has water repelling properties.

5. The liquid ejecting apparatus according to claim 1, wherein the convex portion is formed along the first direction.

6. The liquid ejecting apparatus according to claim 1, wherein a distance from a leading edge of the wiping portion to the apex of the convex portion is equal or less than ten times the distance from the flat portion to an apex of the convex portion.

7. A wiping method of a liquid ejecting apparatus including a liquid ejecting unit that has a nozzle row configured to have a plurality of nozzles lined up along a first direction, and ejects liquid through the nozzles configuring the nozzle row, and a wiping portion that moves relative to the liquid ejecting unit in a second direction intersecting the first direction such that the liquid ejecting unit is wiped, in which the liquid ejecting unit includes a plurality of nozzle rows configured to have a space therebetween in the second direction, a convex portion placed between the nozzle rows in the second direction, and flat portions placed at both sides of the convex portion in the first direction, the method comprising:
wiping the liquid ejecting unit with the wiping portion at a first relative travel speed to collect liquid attached to the liquid ejecting unit to the flat portion; and
wiping the liquid ejecting unit with the wiping portion at a second relative travel speed faster than the first relative travel speed to move liquid attached to the flat portion, after the wiping at the first relative traveling speed.

8. The wiping method of a liquid ejecting apparatus according to claim 7, wherein at least one of the wiping at the first relative traveling speed and the wiping at the second relative traveling speed is performed multiple times.
